(19) United States
(12) Patent Application Publication
(10) Pub. No.: US 2005/0163893 A1
(43) Pub. Date: Jul. 28, 2005

(54) Laminated casing having multiple porosities

(75) Inventor: Neil Mintz, Carlsbad, CA (US)

Correspondence Address: GORDON & REES LLP, 101 WEST BROADWAY, SUITE 1600, SAN DIEGO, CA, 92101, US

(73) Assignee: Jif-Pak Manufacturing, Inc.

(21) Appl. No.: 11/089,646

(22) Filed: Mar. 25, 2005

Related U.S. Application Data
(63) Continuation-in-part of application No. 10/461,305, filed on Jun. 13, 2003.

(51) Int. Cl. A23G 1/00

(52) U.S. Cl. 426/135

(57) ABSTRACT

A casing for containment of a proteinaceous product during or following processing is described. The casing has controlled porosity which permits close control of product drying with protein retention, providing good product color and surface texture, patterned and/or shaped products, high protein content and high peelability. The casing is a laminate of a first lamina having high strength and, optionally, surface pattern-producing capability, and a second lamina of controlled porosity which is permeable by vapors and, in most cases, also aqueous and organic liquids, but which is not permeable to solids such as proteins or fats. The laminae are adhered by an adhesive (preferably thermally activated) or by surface interlocking. Accessory materials such as liquid flavorants, colorants, release agents and anti-microbial agents can be incorporated into the laminae and from there imparted to the product. Applicable proteinaceous products include meat, poultry, seafood, soya and cheese.

### CROSS-REFERENCE TO RELATED APPLICATION

This application is a continuation-in-part of application Ser. No. 10/461,305, filed on Jun. 13, 2003, entitled “Laminated Casing Or Netting For Proteinaceous Products”.

### BACKGROUND OF THE INVENTION

1. Field of Invention

The invention relates generally to casings and nettings for the formation of proteinaceous products, and more particularly for casings and nettings in which such a product is cooked, smoked, chilled, packaged or otherwise processed for market.

2. Background Information

The principal proteinaceous products of interest in the present invention are meat, poultry, seafood, soya and cheeses. For brevity herein these will be exemplified by meat and the description below will refer to “meat” as the product with which the novel casings and nettings will be used. (Meat itself is considered to encompass both white and red meats, and to include but not be limited to beef, veal, mutton, lamb, pork and game meats, whether in whole, separated, cut, ground or other recognized forms.) It will be understood, however, notwithstanding the references to “meat,” that all of the proteinaceous products are intended to be included within the scope of this invention, including not only meat but also the aforesaid poultry, seafood and cheese, and also those less commercially known proteinaceous products such as soya products. Therefore, in the description below the use of “meat” as the exemplified product should not be construed as limiting unless the context so demands.

Casings and nettings are commonly used to encase meat products through the cooking and/or smoking processes, by which the products are prepared for market. Various types of casings and nettings are used, depending on the functions desired, such as the ability to define the finished shape of the product or to impart patterns to the meat surface, and on the properties of the meats involved. Casings such as “fiber reinforced cellulose” (often referred to as “fibrous casing”; see U.S. Pat. No. 4,164,536 [Bentley]), cellulose casings and collagen casings have sufficient desired porosity to permit cooking of the meat through the casings while allowing water vapor to escape during the cooking process; but the porosity is limited so as to prevent the contained meat emulsion from escaping. However, such casings do not impart a surface pattern or natural shape to the meat. Nettings rather than casings are typically used where a surface pattern or natural shape is desired. However, since nettings have a higher porosity than casings, they have significant drawbacks when used on boneless meat products containing emulsion. Meat processors using even closely knitted nettings such as described in U.S. Pat. No. 5,413,148 (Mintz et al.) and U.S. Pat. No. 5,855,231 (Mintz) have experienced peeling difficulties on emulsion-containing meat products. U.S. Pat. No. 5,855,231 suggests laminating a cellulose film to a casing as a means of enhancing releasability, but no enabling implementation of that suggestion is disclosed nor is the extent or configuration of any such laminate identified. It is known that the cellulose film mentioned is actually a cellulosic material, i.e., a chemically modified cellulose, in the nature of cellophane or related materials. Further, it is also known that the nature of cellulosic materials is such that they cannot be laminated to most other materials, and even where lamination might be possible, it is accomplished only with great difficulty. Laminated casings have also been disclosed, for instance in two German references, DE (OS) 38 14 173 (Eichel: 1988) and G 8804 123.9 (Hoechst AG: 1988).

Other methods to obtain the desired porosity while still offering the desired surface pattern have been tried, such as applying elastic netting in conjunction with collagen film onto the meat products. The collagen film, having the desired porosity, cooks onto the meat and becomes the edible surface, while the outer netting provides the surface pattern and shape. This method has the drawbacks of producing a tough rind surface from the collagen, inconsistent shapes, poor machineablity (i.e., the ability to be used on high speed meat stuffing equipment) and high cost.

Whereas traditionally smoking of meat takes place in smokehouses in the presence of actual smoke generated from burning wood or by atomized liquid smoke, liquid smoke is now often applied directly to the casing or netting by the manufacturer. The liquid smoke pre-applied directly to the casing transfers both the color and flavor of traditional or atomized smoking but under much more controlled and cleaner circumstances. Liquid smokes, however, are highly acidic, and therefore create problems with many of the casings when pre-applied. For instance, acidic liquid smoke is very deleterious to cellulose materials, particularly to the commonly used “fibrous casing” cellulose materials, in that it causes the cellulose to become quite brittle. To counter this, manufacturers of cellulosic casings must use buffered liquid smoke, to apply to their casings, to reduce the acidity. However, this in turn has the disadvantages that the smoke flavor is degraded, the color of the meat product is less attractive, and the cost of buffered smoke is high.

“Cooking yield” refers to the meat product weight after cooking as a percentage of the product weight before cooking. The processes involve not only the cooking and smoking steps themselves, but also allowance must be made for drying the meat product to provide the meat surface and internal texture desired by the customer. Many of the commercial casings and nettings in current use are either too porous, like netting, which result in lower cook yields, or not porous enough, like fibrous casings, which dry more slowly, and therefore extends the cooking time and limits the cooking yield.

It would therefore be of substantial interest within the meat production and packing field to provide a casing product and its method of manufacture such that it would have the synergistic effect of combining the positive properties of low porosity casings and high porosity nettings so as to provide superior physical and processing properties including but not limited to many or all of controlled porosity, being durable and peelable from the meat without damage to the meat, allowing use of conventional non-buffered smoke products, provide good meat product color, maintaining protein content, provide uniform meat product properties on a sustained production basis, and improving cooking and chilling yields.

### SUMMARY OF THE INVENTION

The invention described and claimed herein is a new type of casing device/product which synergistically combines the best properties of high porosity nettings and lower porosity casings. Meat products cooked or smoked (as well as subsequently chilled or packaged) in the casing products of this invention have desired degrees of dryness, easy and uniform application of conventional liquid smoke, good color and surface texture, may be optionally patterned and/or shaped, can contain a high emulsion content and good peelability. It has not previously been possible to obtain all of these capabilities in a single casing product.

The invention to which these properties pertain is a novel casing product which is a laminate structure composed of a first lamina having high strength and, optionally, surface pattern-producing capability, including the capability to produce three-dimensional patterns, and adhered thereto a second lamina of controlled porosity. The second lamina's porosity is such that during processing (stuffing, cooking, smoking, chilling and the like) it allows passage through it of non-solid materials but not for solid materials. The two types of materials can be identified and differentiated by their physical state as liquid or vapor (i.e., non-solid) on one hand and solid on the other. Materials of most interest are the proteins and fats exuded by the meat product during processing, and flavorants and colorants (such as liquid smoke and/or caramel coloring) which may be incorporated into the meat or added within the casing during manufacturing. By this controlled porosity the meat product can be cooked or smoked to a desired degree of dryness with desired retention of proteins and fats while obtaining the desired color, flavor and appearance. The retention of the proteins results in elimination of protein buildup on the exterior of the casing, which in turn results in good surface quality and color of the meat product upon peeling of the casing, since there are no evolved protein masses to tear away the meat surface. Retention of fats will be a function of both the controlled porosity of the laminae and the temperature of the processing. (As will be described below, some suitable lamina materials will pass vapors but not liquids while others will pass both. For convenience herein both liquids and vapors are frequently mentioned together with respect to the lamina materials. The reader skilled in the art will recognize that when the context is specific to the “vapor-permeable-only” materials, only vapor passage is intended.)

The first lamina is a highly porous knitted fabric such as jersey or similar fabrics. It may be formed as a fine knit or a coarse knit (open mesh) or a intermediate thereto. Both fine knit fabrics and open mesh fabrics are preferred, dependent on the embodiment desired, as will be discussed below. The yarn and structure of the first lamina fabric will be of sufficient strength, weight and resistance to stretching to provide shape and any surface texture or pattern to the meat product. Where the embodiment is of a coarse knit, the open mesh will form a pattern of open squares, rectangles or polygons (typically hexagons) or a mixture thereof, such as a series of octagons interspersed with squares (diamonds). The first or base lamina serves to restrain and shape the meat and usually also to support the second lamina, and may also impart a pattern to the surface of the meat product. This knitted tubular lamina can be made of a variety of yarns including nylon, cotton, rayon, acrylic, polyolefin and covered rubber yarns, but the preferred yarn is of polyester fiber or filament. The open mesh may have a further finer filler knit fabric to fill the open spaces. The filler knit fabric will be of the same or different material or knit style as the base fabric and may further serve to shape the meat product and restrain and support the second lamina.). The fine or filler knit may be of any convenient operable style, including but not limited to jersey, pique, rib and lacoste, with jersey usually preferred. Examples of first lamina fabrics would be those as illustrated in U.S. Pat. Nos. 5,413,148 and 5,855,231. In other embodiments either a fine knit or a coarse knit base fabric (the latter with or without a filler fabric) may be reinforced by heavier strands interspersed therethrough, providing reinforcement, high shrink or both. In yet another embodiment the lamina may be made of or contain a high shrink yarn which when cooled after being heated when the meat is cooked, smoked, etc., shrinks and produces good definition of a pattern imparted to the surface of the meat.

The second lamina is a thin porous sheeting material that is impervious to meat solids but which is porous to non-solid passage of vapor and also, in many cases, liquid, including water and aqueous- and organic-based liquids. This permits adequate drying of the meat by evaporation of water from the meat and also passage into the meat of desired liquids and vapors such as smoke. The second lamina has good wet strength to enable liquid and vapor passage without deterioration of the lamina during cooking, smoking, etc., but the lamina will not have sufficient wet strength to be self-supporting. It will also be sufficiently acid-resistant to allow it to be in contact with acidic materials such as conventional liquid smoke for prolonged periods of time. Suitable second lamina materials include but are not limited to nonwoven filter media; microporous filter papers; and polymeric films, including microporous films made of polyolefin, nylon or polyester. Most preferred are the high wet strength papers, such as papers made from fibers such as abaca pulp (also known as Manila hemp), wood, cotton or glass, many of which are frequently used as filter media or separating membranes, and particularly those which are used for teabags. Most of the polymeric film materials will be permeable only to vapor rather than to both vapor and liquid.

Adhesion of the two laminae is through an adhesive material or self-bonding of the laminae. The adhesion is such that when the casing is to be removed from the meat product, the entire casing peels easily and cleanly from the meat product, leaving no casing remnants, tears or gouges in the meat surface, discolorations or mottlings of the meat surfaces, or other unwanted results. An adhesive material can be a pressure sensitive contact adhesive material which adheres to each lamina surface upon contact and application of pressure to the adhesive and lamina, or it can be an adhesive which is activated by application of heat or radiation or by use of an activating solvent or chemical, such as by application of water. The adhesive may be initially present as a coating on one or both of the laminae, on the opposed surfaces, or adhesive may be incorporated into one or both of the laminae in a manner that places it at the surface or from which it can migrate to the surface in order to effect the adhesive bonding upon application or heat and/or pressure. Preferred is a heat activated adhesive such as polyethylene, polypropylene, ethylene vinyl alcohol, and the like which may initially be disposed as a surface coating or embedded component.

In use the casing may be formed initially as a hollow tubular container initially open at both ends, with one end being sealed (as by heat, stitching, pressure, chemical action, clamping with a clip or collar, etc.) prior to insertion of the meat for cooking, smoking, and other processing, Such a tubular container may be in single unit lengths or, more preferably, as a long extended sleeve, into which meats are placed seriatim and then the sleeve is sealed or closed sequentially along its length to enclose each meat product into its own container segment in a sausage-like configuration, with the individual segments subsequently being cut apart from each other. Alternatively, the casing may be formed as a flat sheet which may extend significantly in one direction to form a long narrow strip which could be turned laterally to overlap the edges and form a tube and the seam formed by the overlapping edges then sealed by heat, chemical adhesion and/or pressure.

Either of the two laminae may be on the “inner side” (“meat side”) of the casing in contact with the meat product, with the other lamina on the opposite “outer side”. Preferably the first lamina will be on the outer side and the second lamina will be on the inner side.

Details of the invention and further descriptions will be found below.

### BRIEF DESCRIPTION OF THE DRAWINGS

FIG. 1 is a schematic plan view of a segment of a first lamina showing a basic knitted fabric with optional restraining/reinforcing yarn strands;

FIG. 2 is a schematic plan view of an embodiment of the first lamina similar to that of FIG. 1 but wherein the fabric has open spaces in which there is an optional finer filler knit, and also showing optional restraining/reinforcing yarn strands;

FIG. 3 is an oblique exploded schematic view of a casing of this invention showing a first lamina similar to that of FIG. 2 and a second lamina and also illustrating adhesive means to adhere the two together;

FIG. 4 is a schematic diagram of one embodiment of the method of manufacturing the laminated casing product.

FIG. 5 is a schematic diagram of another embodiment of an open mesh lamina, illustrating openings with a hexagonal shape.

### DETAILED DESCRIPTION AND PREFERRED EMBODIMENTS

The invention described and claimed herein overcomes the deficiencies of the prior art casings and nettings by synergistically combining the desirable properties of two different materials into a single laminated device. In its broadest form, the invention is defined as a casing/netting device in which a first lamina of good strength and shape-forming capability is laminated to a second lamina of a controlled porosity material which has wet strength but is not self-supporting. The first lamina's strength is sufficient to maintain a desired outer dimension and to define and maintain the shape of the food product. The second lamina's controlled porosity is such that non-solids (vapor and also usually liquid) can pass through it to and from the cooking meat but solids within the meat are retained. This permits the meat to achieve a desired degree of dryness but still retain important solid components such as the meat proteins and much or all of the meat fats. The second lamina is also resistant to acidity such that acidic materials such as liquid smoke can be used on the meat products. The laminae are adhered to each other by an adhesive material or by fusion of the contacting surfaces of the laminae. Each of the lamina will be described in more detail below, particularly with reference to the Figures of the drawings.

For brevity herein, the overall product will be referred to generally as a “casing” which will for the most part be considered to encompass a “netting.” Only in a context where the respective properties of the individual laminae are of significance will either “casing” or “netting” be used in its more limited and specific meaning. The person skilled in the art will therefore be aware that the term “casing” as used herein should be considered to refer to the overall device of the invention unless the context demands otherwise.

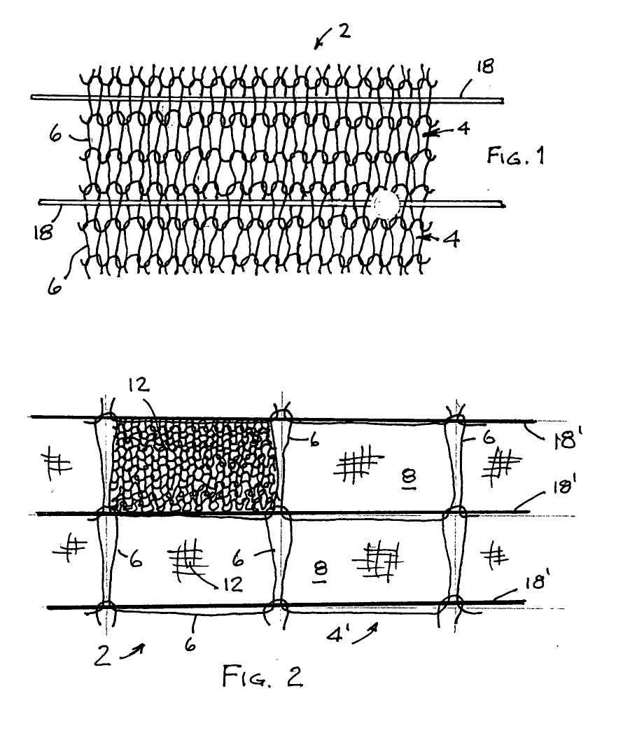

A principal component of the casing 10, a first lamina 2, is illustrated in the embodiment of FIG. 1. The first lamina 2 is formed from a “base” fabric 4, which is a knitted fabric composed of a substantially non-elastic yarn 6. The fabric 4 may be formed of finer or coarser knits. For the purposes of this invention, a “finer” knit will be defined as having on the order of 10-80 courses (horizontal rows) per inch (4-32 courses per cm), more preferably 30-50 courses per inch (12-25 courses per cm), and on the order of 5-25 wales (vertical chains) per inch (2-10 wales per cm), more preferably 8-15 wales per inch (3-6 wales per cm). The coarser knits, which sometimes will be referred to as “open mesh” knits, will be described in more detail below. The embodiment of fabric 4 illustrated in FIG. 1 is a finer (“fine) knit. The knit may be of any convenient style, including but not limited to jersey, pique, rib or lacoste, of which jersey is frequently preferred. Those skilled in the art will be readily able to determine the preferable style for any particular casing. The yarn and fine knit of the fabric will often be of sufficient strength and resistance to stretching to provide shape and, if desired, any surface texture to the meat product. The yarn and knit also provide the strength needed to withstand the stuffing pressure of the filling meat, since the meat must be stuffed into the casing under sufficient pressure to eliminate internal voids and give a consistent shape. The knitted sleeve can be produced by a variety of knitting machines including circular single knit, circular double knit, rib machine and warp knitting machines, of which the preferred machine is a small diameter (4″-8″ [10-20 cm]) single knit circular knitting machine.

In those embodiments in which the yarn 6 and the structure of the fabric per se may not be sufficient to resist stretching or provide shape or texture to the product, one may use an alternative embodiment, also illustrated in FIG. 1, in which separate strong and/or heavy restraining (reinforcing) strands 18 are laid or knitted into the fabric 4 at intervals, such as by a tuck stitch, to assist in imparting the desired surface texture and/or definition to the meat product and/or to enhance the strength of the fabric 4. In this alternative embodiment of FIG. 1 with a finer knit base fabric 4, the strands 18 are commonly spaced at about 10-20 per inch. Non-elastic or low stretch restraining strands 18 provide a high degree of diameter control which is especially important in slicing applications where each slice must be of the same diameter or for exact weight applications. Additionally, the restraining yarns 18 help prevent the second lamina 14 (described below) from tearing when the casing is filled under pressure with the meat product. If desired, as an alternative restraining strands 18 can be made of elastic yarn like covered rubber to provide a natural shape (for example, a football or spherical shape) to the meat product.

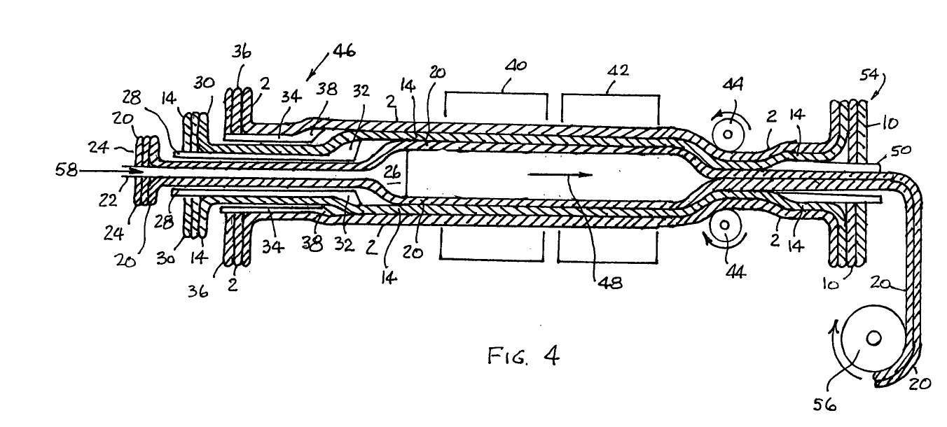

As is illustrated in FIG. 4, the fabric of the casing 10 is usually knitted in a tubular sleeve form, so that the meat product can be inserted into the sleeve and the ends sealed, as will be discussed in more detail below. The yarn 6 of these knitted fabrics 4 can be made of a variety of fibers including nylon, cotton, rayon, acrylic, polyolefin and covered rubber, but the preferred fiber is polyester. The restraining strands 18 are commonly made of similar fiber materials, but are typically heavier. As noted above, unlike the non-elastic yarns 6 of the fabric 4, the restraining strands 18 may be of different degrees of elasticity, from non-elastic or very low stretch yarns to yarns having substantial elasticity. Those skilled in the art will be able to determine readily the appropriate degree of elasticity of strands 18 for any desired casing 10.

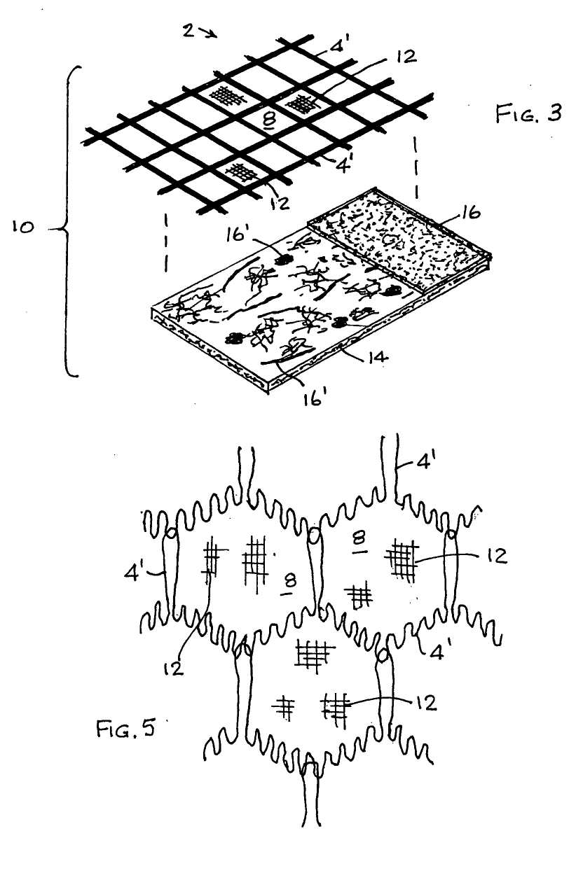

FIG. 2 illustrates a first lamina 2 similar to that of FIG. 1 but in which the base fabric is formed by yarns 6 as an open mesh, i.e., with a coarse knit, in which there are large openings 8. (For convenience in differentiating in the discussion herein between a base fabric with a finer knit and one with a coarser knit, the former will be indicated by numeral 4 as in FIG. 1 and the latter will be indicated by numeral 4′ as in FIG. 2. It will be understood, however, that both fabrics 4 and 4′ serve the base function in their respective embodiments, and therefore represent a single element of the present invention.) Commonly the openings 8 in fabric 4′ are generally rectangular in shape, as shown in FIG. 2, in which case the length of a side of an opening 8 is preferably on the order of ⅛-2 inches (3-50 mm), more preferably ¼-1 inch (6-25 mm). However, as illustrated by the hexagonal configuration of FIG. 5, the openings 8 may be of many different shapes, including but not limited to square, rectangular, polygonal (especially hexagonal or octagonal) or rhomboidal. One may also include a mixture of shapes, such as for instance octagonal openings interspersed with square/diamond-shaped openings, or have the open shapes be formed by spiral winding of the yarns 6, as desired. It is also possible to impart a third dimensional outward bulge within a surface pattern, such as illustrated in U.S. Pat. Nos. 5,413,148 and 5,855,231 and U.S. Design Pat. No. D-401,385 (all to Mintz or Mintz et al.). It will be recognized that since the meat products to be encased are of various shapes, many of which are not regular geometric shapes, there are usually many different resultant shapes among the individual openings 8 in a single casing after the meat product is inserted into the casing, notwithstanding that before insertion of the product all of the openings 8 had been knitted substantially in a single shape as part of fabric 4′. Therefore, the opening 8 shapes illustrated in the Figures herein, and the opening 8 dimensions stated above, are to be considered representative only, and those skilled in the art will be readily able to determine the optimum opening size(s) and shape(s) for any particular casing 10 of interest.

It is common that a casing 10 may be made entirely of an open mesh fabric 4′ formed by yarns 6 with openings 8, and that such will be fully functional to encase and shape a meat product, in the same manner as described above for the casing composed of the finer knit fabric 4. The same yarn 6 materials as described for fabric 4 are applicable to fabric 4′, except as described below. As between these two embodiments, the choice will be readily made by the person skilled in the art based on such well-understood factors and the nature of the meat product of interest, the type of handling and processing that the product is to undergo while encased, and the equipment available.

In another alternative embodiment, the open mesh fabric 4′ is supplemented by a finer filler knit fabric 12 which fills the openings 8. This finer filler knit fabric 12 is usually of about the same scale as the fine knit base fabric 4 of FIG. 1. To some extent, this embodiment may be considered in effect to combine the fabrics 4 and 4′ in a single casing 10. However, while the finer filler fabric 12 may be of the same type of material as the coarser base fabric 4′, that is not necessary, and the fabric 12 may be of different material and/or a different knit pattern than the fabric 4′. In particular, the filler knit 12 will normally be of a lighter lower denier yarn, so that the overall pattern of filler knit 12 is finer and more closely knit than that of the coarser basic fabric mesh 4′, usually with the scale differences being about the same as the differences between fabric 4 and fabric 4′. The filler knit fabric 12 may also be formed of the same yarn materials and in the same knit patterns as described above for fabric 4; preferably it will be constructed of jersey stitches. It is also contemplated that the filler knit fabric can stretch beyond that of the open mesh of fabric 4′ to accommodate the bulging of the meat product when a three-dimensional pattern is imparted to the meat surface. The filler fabric 12 also serves to assist the open mesh fabric 4′ in supporting and maintaining the second lamina when the two laminae are adhered together.

In an embodiment as illustrated in FIG. 2 (and also applicable to FIG. 5), heavier strands 18′ may be incorporated into the fabric 4′ formed of the non-elastic yarns 6. The strands 18′ are preferably spaced at 1-4 strands per inch (6-25 mm between strands). The strands 18′ may be similar to strands 18 in the embodiment of FIG. 1 in provision of reinforcement. However, in the embodiment of FIG. 2 either or both of the strands 18′ and the yarns 6 may also be formed of materials which have high shrink properties which supplements their other properties. Examples are high tenacity polyester or nylon yarns of heavier denier. The high shrink property is activated during the manufacturing process described below, when the laminated product passed first through oven zone 40 and then through cooling zone 42. The strands 18′ help provide a high degree of diameter control which is especially important in slicing applications where each slice must be of the same diameter or for exact weight applications. Additionally, they help prevent the second lamina 14 (described below) from tearing when the casing is filled under pressure with the meat product. The high shrink property produces good definition of a pattern imparted to the surface of the meat.

The second lamina 14 is made of a thin porous sheeting material that is impervious to meat solids but which is porous to passage of vapors, including water vapor, and, in many cases, also liquids including liquid water and aqueous- and organic-based liquids. This permits adequate drying of the meat by evaporation of water from the surface of the meat and also passage into the meat of desired liquids and vapors such as flavorants (e.g., smoke) and/or colorants (e.g., caramel coloring). The inner lamina must also have sufficient wet strength to enable liquid and vapor passage without deterioration of the lamina. However, it will not be sufficiently strong to be self-supporting when wet. It will also preferably be suitably resistant to acidity, and when conventional unbuffered liquid smoke is being used it must have sufficient resistant to acidity to be unaffected by the acidity of the liquid smoke composition. Suitable materials include but are not limited to nonwoven filter media and thermoplastic polymeric films (including microporous films made of polyolefin, nylon or polyester), such as are frequently used as filter media or separating membranes. Most preferred are the high wet strength papers. Particularly preferred high wet strength papers are those abaca pulp (also known as Manila hemp), which may be coated to enhance its properties; abaca pulp is commonly used in teabags. Other high wet strength papers include those made of wood fibers, glass fiber membranes or cotton fibers. Treatment of such materials may be required or desirable to improve wet-strength; for instance wood fibers are known to be amenable to being treated with polyvinylalcohol/melamine formaldehyde resins to provide appropriate wet strength. Desirably the second lamia material will also have sufficient absorbency to hold and deliver accessory materials such as flavorants or colorants, particularly conventional liquid smoke compositions. (Useful descriptions of formation and properties of many suitable materials for both laminae will be found in numerous literature sources; see, e.g., Corbman, TEXTILES: FIBER TO FABRIC (5th ed., McGraw-Hill Book Co.: 1975; see also the definitions of papers and non-woven materials in ISO [International Organization for Standardization] Standards 4046 and 9092, respectively.) From the descriptions herein those skilled in the art will be readily able to select the optimum materials for their particular end use applications.

The non-solid materials to which the second lamina material will be permeable will be vapors and, in most cases, also liquids. All of the second lamina materials contemplated will pass vapors, including water vapor and smoke. Many will also pass liquids, such as liquid water or aqueous- and organic-based liquids such as solutions or the liquid portion of suspensions. The papers and nonwoven filter media normally will pass both liquids and vapors. The polymeric films, however, are normally of porosities which will pass only vapors. The nonwoven filter media useful herein are those common to the industry, which are generally defined as those materials formed by being spun bonded or melt blown (both usually from polyolefin, polyester or nylon fibers) or wet laid or dry laid (both usually from microglass or polymeric fibers). Nonwovens are considered in the art not to be knit, woven or paper materials. Passage of vapor through the second lamina material is critical, since drying of the meat occurs by evaporation of water which exudes from the meat as vapor or liquid, and smoke, whether from liquid smoke absorbed into a lamina fabric or present as a vaporous environment surrounding the casing and meat, passes into the meat as vapor. The ability to pass liquid in addition to passing vapor is very useful and desirable in the present invention, but whether a user selects papers or nonwovens (which pass both) or polymeric films (which normally pass only vapors) will be merely a matter of choice based on the overall factors of the meat products and production conditions of interest to the user.

The relative porosities of the first and second laminae 2 and 14 will be understood by those skilled in the art of meat casings and nettings. While the specific porosity values will vary from material to material, the relevant distinction for the purpose of this invention is that the laminate's controlled porosity allows for passage of non-solids and prevents the passage of solid materials. This is considered to mean that under the normal environmental conditions of the casing's use, solid materials such as meat proteins and higher molecular weight fats will be retained within the meat, while liquid and vaporous materials such as liquid water, aqueous- and organic solutions, water vapor, liquid portions of suspensions and liquefied meat components will be able to pass through the casing upon being exuded from the meat. Similarly, such non-solid materials will be able to be delivered to the meat from outside the casing or from coatings on or components within the casing if desired. Whether a particular material is a solid or non-solid will often be dependent on the internal temperature reached by the meat product during cooking or smoking (recommended internal cooking temperatures of meats are usually up to about 185° F. [85° C.]). Meat fats are normally solids at lower temperatures but as the temperature is increased, some of the fats may reach their melting temperature and will liquefy. Even when liquefied, however, many of the previously solid materials will still for the most part be retained within the casing since their molecular weights and configurations impede their movement though both the body of the meat and the inner lamina, so that only limited exudation occurs during the cooking or smoking process. The first lamina may have the same degree of controlled porosity but commonly will be more porous and may be substantially of open mesh structure. Whether a particular material is suitable as a second lamina as opposed to a first lamina, or vice versa, in this invention can be easily determined by one skilled in the art by a simple measurement of the non-solid versus solid passage characteristics of the material for the meat product of interest.

Either of the laminae may be used on either side of the casing product, whether on the “inner” side in contact with the meat product or on the opposite or “outer” side. It is preferred that the second lamina 14 be on the inner side to maximize the supporting properties of the first lamina 4 and to enhance the ease of separation of the casing 10 from the meat product by the user.

Adhesion of the first lamina 2 to the second lamina 14 is through adhesive means as illustrated in FIG. 3, in which the first lamina 2 is illustrated as having an open mesh base fabric 4′ with a filler fabric 12 and restraining strands 18. (It will be understood that this is merely for illustration purposes, and that FIG. 3 is applicable to all of the different embodiments of first lamina 2.) It is of critical importance that the adhesive be such that the two laminae do not separate from each other, whether in handling or in processing. When the casing is removed from the meat product the adhesive must continue to prevent delamination of the two laminae but not restrict clean and easy separation of the casing from the meat product, without damage to the meat product surface or any pattern which has been imparted to the meat product by the casing. Thus any adhesive or material which acts as an adhesive (such as collagen in many situations) and which when in a casing adheres to the surface of the meat product with sufficient strength or which has insufficient adhesive strength to prevent delamination of the casing, cannot be used in the present invention. Thus prior art products in which an outer netting separates from an inner collagen, fibrous casing, or similar layer are much inferior to the product of this invention.

Adhesion can be by use of an adhesive material 16 such as a pressure sensitive contact adhesive composition which adheres to each lamina surface upon contact and application of pressure to the adhesive and lamina or the adhesive composition can be activated by application of heat or radiation (e.g., RF bonding) or by use of an activating solvent or chemical, such as by application of water; the heat activated adhesives are preferred. The adhesive can be applied or present as a continuous film precoated on the contact side of either or both of the laminae, or it can be applied in a discontinuous pattern. If a continuous coating is applied, it must be one which does not itself create a barrier to permeation of the water from the meat for drying. Alternatively the adhesive may be embedded in or at the surface of one or both of the laminae, as indicated as discrete regions or filaments 16′. Embedded adhesive materials must be such that at least in part they migrate to the contact surface of the lamina in which they are embedded so that adhesion can be affected. Heat activated adhesives such as hot melt adhesives may include, but are not limited to polyethylene, polypropylene, ethylene vinyl alcohol, and the like. Since it is intended that the casing will be removed from the meat product by the user the adhesive does not itself have to be edible. It will however normally be required to be of food contact grade purity and composition. If either of the laminae are made of a thermoplastic material (e.g., polyester knitted fabric or polypropylene nonwoven material), then it is necessary to select an adhesive having a significantly lower melting temperature than that of the thermoplastic lamina, so as not degrade the strength of lamina during thermal lamination. Similar considerations for avoidance of damage to the laminae will also be present for radiative, solvent or chemical activated adhesion with an adhesive material.

Alternatively, the adhesive region 16 can be a zone of direct adhesion of the two laminae to each other such as by thermal, radiative, solvent or chemical modification of the contact surfaces of the two laminae. Adhesion by thermal, radiative, solvent or chemical modification of the laminae contact surfaces themselves (i.e., “self-bonding”) will of course have different considerations than bonding with an adhesive as described above, in that the purpose here is to physically modify the contact surfaces sufficiently to cause them to form a conjoined matrix in region 10 in a manner somewhat analogous to formation of a weld between adjacent metals. Self-bonding can be considered to be interlocking of the opposing surfaces of the two laminae while in contact and which is produced by thermal, radiative, solvent or chemical induced mutual disruption of the opposing surfaces and subsequent merger and stabilization of the disrupted surfaces. Self-bonding adhesion is less desirable than use of adhesive materials because of the difficulties of obtaining a uniform adhered zone which does not materially affect the water expulsion from the meat during drying.

The laminated casing 10 can be formed as a hollow tubular sleeve configuration or as a flat sheet. In order to form a container for the meat product, a tubular sleeve will first be closed at one end by any suitable means, which includes but is not limited to heat- or adhesive-sealing, crimping with a clip, or other means well known in the art, to form a pouch. The meat product is then placed inside the pouch and the sleeve is crimped or sealed behind the meat product to form the container. A continuous series of such pouches can be formed, filled and sealed, sausage-fashion, and then subsequently cut apart into individual containers, or each container can be severed from the sleeve seriatim. Alternatively, when the casing is initially formed as a continuous flat sheet, it can be folded onto itself longitudinally with the mating edges overlapping to form a seam, and then the seam is sealed to form a tubular sleeve. Additionally, the continuous sheets can be formed into pouches of various shapes (example: teardrop, heart shape, etc) by applying a pattern to seam the edges.

Manufacture of the casing product of this invention can be accomplished by various methods or steps. A schematic diagram of one embodiment of the method of manufacture is illustrated in FIG. 4. In this embodiment each lamina (and the bladder) may be first formed as an elongated hollow cylindrical tube in a conventional manner, as by forming the lamina in a flat sheet, rolling it into an elongated cylindrical form and adhering the overlapped longitudinal seam using any of a number of known methods (e.g., heat sealing, adhesive bonding, tape application). This initial step is not shown in FIG. 4. Preferably, the first lamina 2 is manufactured in tubular form directly on circular knitting machines, thereby not requiring the seaming operation. Similarly, the bladder, depending on the material used, may be directly extruded in tubular form. In order to help prevent tearing of the second lamina 14 or accommodate three-dimensional profiles when subsequently stuffed with the meat product, it is preferred to have the second lamina be the inner lamina of the casing and for it to have a maximum circumference slightly larger than that of the outer knitted first lamina.

In the manufacturing process embodiment shown in FIG. 4, the tubular laminae and bladders are all shown in cross section so that the process depicted may be better understood by readers skilled in the art. Since the laminae and bladder are tubular, each component appears as a pair of parallel cross-sections extending along and on either side of the longitudinal centerline of the diagram. Formation of the laminated casing starts with three initial materials: the first knitted lamina 2, which is illustrated as the outer lamina, second lamina 14, which is the inner lamina, and a bladder 20. In this embodiment all three materials are usually batched for convenience in lengths of 100-1000 feet (30-300 m). The bladder 20 is made of a film that can contain air without leaking, typically a thermoplastic. In this embodiment, since it must be sustained in oven temperatures the bladder is made of a high-temperature-stable (i.e., stable at up to about 550° F. (290° C.)) polytetrafluoroethylene (PTFE: “Teflon”@) sheet. The bladder 20 in tubular configuration is shirred onto an inner rigid hollow guide tube or mandrel 22 as shown at 24 and extended forward along inner tube 22 to a bell-shaped expander or spreader 26 at the opposite end of inner tube 22. The distal end of expander 26 will have at least one air flow aperture (such as a plurality of small holes, a larger central aperture, etc.) for air flow purposes as well be described below. Inner tube 22 and bladder 20 are disposed within and coaxial with a middle rigid hollow guide tube or mandrel 28 onto which is shirred the inner second lamina 14, as shown at 30. As with the bladder 20, the second lamina 14 is extended forward to bell-shaped expander or spreader 32 at the opposite end of middle tube 28 and then on past expander 26 to overlie bladder 20. This entire assemblage in turn is disposed within and coaxial with outer rigid hollow guide tube or mandrel 34 onto which is shirred the outer first lamina 2 as shown at 36. As with second lamina 14, the first lamina 2 is extended forward to bell-shaped expander or spreader 38 at the opposite end of outer tube 34 and then on past expander 26 to overlie both inner second lamina 2 and bladder 20. Thus as the laminae and bladder move beyond expander 26 they are in the configuration of a hollow elongated tube having three adjacent and contacting coaxial layers: the bladder 20 on the inside, the second lamina 14 in the middle, and the first lamina 2 on the outside. The adhesive material (not shown) will be disposed between or within the laminae 2 and/or 14 as described above in the description of FIG. 3. There is no adhesive between the inner lamina 14 and the bladder 20.

The tri-layer assemblage is initially threaded through oven zone 40, cooling zone 42 and powered nip rollers 44. Compressed or otherwise pressurize air is injected into the outer end of tube 22 as indicated by arrow 58 and flows through tube 22 and exits into the spread, hollow interior of bladder 20, as indicated at flow arrow 48, thus maintain bladder 20 in an inflated and expanded configuration, thus also simultaneously expanded laminae 2 and 14 in an equivalent manner. Thereafter during manufacturing the nip rollers 44 draw the three materials in expanded form simultaneously and evenly forward from their respective shirred positions through the oven zone 40 and cooling zone 42, also as indicated by the arrow 48. The oven zone 40 operates at temperatures suitable to heat-activate the adhesive 16 and bond the two laminae 2 and 14 together. For many adhesives the effective temperature will normally be in the range of about 250° F.-600° F. (120′-315° C.), preferably in the range of about 400° F.-475° F. (205° C.-245° C.). The residence time in the oven zone 40 for a given point along the tubular assemblage is commonly on the order of about 20 to 60 seconds. The oven zone 40 will be sized to provide the desired residence time as a function of the speed at which the tubular assemblage in pulled through the oven by the nip rollers 44. The tubular assemblage in which the adhesive has now been activated continues on into and through the cooling zone 42, in which the assemblage is cooled down to a temperature in the range of 40-70° F. (5-21° C.) to allow the now-bonded laminated casing 10 to be easily handled. Cooling can with some adhesives also strengthen the adhesive bond. Similarly, as the assemblage passes through the nip rollers 44 the laminae are subjected to pressure, which will induce any pressure-activation of the adhesive. If desired the nip-rollers 44 may also be heated to further enhance any heat activated adhesive bond. Additional or alternative adhesive activation equipment (not shown) can also be present between the material feed area 46 and the nip rollers 44, such as RF-emitting equipment if the laminae are to be RF-bonded or chemical or solvent application equipment if the laminae are to be chemical or solvent bonded.

As the air-expanded bladder 20 and laminae 2 and 14 travel through oven zone 40, the lamination of the laminae 2 and 14 takes place. This ensures the consistency of the positioning of the two laminae relative to each other and to ensure that the there are no folds in either lamina, the inner lamina being especially prone to folding or kinking. Elimination of folds or kinks is important to prevent the inner lamina from tearing when stuffed with the meat product under pressure. Fully expanding the aligned laminae within bladder under pressure also ensures compression of the laminae during lamination, especially when using heat activation of the adhesive. For casings comprising design patterns which preferably contain three dimensional outward bulges (e.g., patterns of rectangles), the air pressure within bladder 20 will need to have the capability to expand the casing to form the bulges during lamination. The laminae remain expanded through the cooling zone 42, which maintains pressure between the laminae surfaces, to ensure proper dwell time.

After the assemblage passes through the nip rollers 44 the bladder 20 is separated from the now-bonded casing laminate comprising the first and second laminae 2 and 14. In the embodiment shown in FIG. 4, a separator tube 50 has its leading edge inserted between the bladder 20 and the inner lamina 14 so that the bladder 20 is separated from contact with the casing 10 for separate collection, as by being pulled onto collection roll 56. Casing 10 separately is shirred in collection area 54 from which it can be removed and packaged. There are other effective means of separating the bladder 20 from the casing 10 which will be readily apparent to and useable by those skilled in the art.

Since many materials useful as the laminae will be absorbent, accessory materials such as flavorants (e.g., smoke flavoring), colorants (e.g., caramel coloring for dark or black colored meat products), release agents, anti-microbial agents, browning agents for golden oven roast applications and the like can be pre-applied to the laminae for added market value of the final meat product. For example, smoke can be added, which provides a desirable color and flavor to the meat, eliminating the need for the meat processor to have an extra smoking step with its associated costs. Smoke may be applied as a liquid to the casing from which it vaporizes and passes into the meat as a vapor, or as a vapor from a vaporized smoke generator outside of but proximate to the encased meat, such as in a smokehouse. As discussed above, liquid smoke compositions are highly acidic, such that many materials and prior art casings (especially casings comprising cellulose, like fibrous casing) cannot be used with them without deleterious effects. This invention therefore is superior to those prior art products and processes, since it does not need to use expensive buffered smoke products; the ability to use conventional smoke materials also leads allows production of more flavorful and better appearing smoked meat products.

The casings of this invention provide many benefits in combination to the meat processor. While some of these benefits are provided individually by prior art products, they are not found in such a broad combination in any single prior art product. Meat processors have therefore previously had to select casings knowing that any such selection necessarily meant that one or more desired properties and benefits could not be obtained from the selected casing. In the present casing device, however, a large number of benefits are for the first time found in a single product.

The casing is very durable and machinable (i.e., it is able to run on automatic high speed meat stuffing equipment), and is strong enough to withstand the high internal stuffing pressures which are necessary to prevent voids in the meat product and give a consistent shape to the meat product. The casing is able to tolerate the extended time (e.g., eight hours) of cooking and/or smoking processes at temperatures up to 190° F. (88° C.), which usually includes significant time at elevated humidity and steam cooking, as well as the subsequent chilling process.

The preferred laminae materials of the present invention dry faster than many of the prior art casings, particularly those which incorporate cellulosic material (e.g., fibrous casing). Consequently, the casings of this invention allow the meat processor to markedly speed up cooking, smoking and many other aspects of the processing of the meat product. This results in significant improvement in the cooking yield for the processor, which in turn allows the processor to produce more product with the same processing equipment or produce the same amount of product with less or smaller equipment, both of which are of course financially advantageous for the processor.

The casing of this invention has excellent peelability, in that it can be removed quite easily from the meat surface since no part of the casing becomes embedded into the meat product, a common failing of prior art nettings. Downgrades due to meat tears are eliminated. Most importantly, the inner lamina material does not adhere to the meat's protein surface. Various release agents can be pre-applied to the inner surface of the casing, if necessary, to further enhance the peelability. Further, the lamination is strong enough to hold up through all processes, so that the casing, when removed, is intact and has not delaminated, so that it does not leave any fragments on the meat product.

Good color development requires adequate surface drying. Due to the high degree of “breatheability” of the casing and the consistency of lamination adhesive, the color development is excellent and consistent. Previously the prior art casing/netting products allowed at least some protein through, even when made of closely woven materials (like those described in the aforementioned U.S. Pat. Nos. 5,413,148 and 5,855,231) were used, which resulted in light spots appearing on the meat surface in areas where protein exudate penetrated the net and developed color on the outside of the net. The exudate was then torn away when the casing/netting product was removed, leaving the undesirable light spots on the unwrapped meat product. The casing of this invention, even when stuffed with small emulsion meat products (e.g., sausage, bologna, emulsion ham or poultry) does not allow the protein to exude through.

In addition, by having the synergistically combined porosity from the two laminae, drying or the meat product during cooking is controlled to allow for just the desired amount of drying (i.e., water removal) for optimum color development and meat texture, without affecting cooking and chilling yields. This also results in no protein being lost through the casing. Further, the controlled porosity also minimizing drip loss of moisture, especially on high pump (i.e. brine injection) products.

Stuffing and cooking, smoking and chilling procedures using the casing of this invention will be substantially the same as with prior art casings and will normally use existing stuffing equipment. As a general description, when in use the casing will normally be in the form of an extended sleeve material many feet/meters long. To form a bag-like container for each meat product a predetermined length of the leading end of the sleeve is cut from the sleeve and one end closed and secured by a collar or clip. Alternatively the extended length sleeve is shirred for continuous stuffing on an automatic stuffing machine. The meat product will then be stuffed into the open end of the sleeve, with the meat product and sleeve then conforming to substantially the desired shape of the intended commercial meat product. The casing bag will constrain the meat into the desired shape and may be such as to impart a surface pattern or texture to the meat product. Following completion of stuffing the trailing end of the bag may be closed and sealed with a collar or clip usually in the same manner as closure of the leading end of the bag. Alternatively, especially with automated stuffing equipment, a substantial quantity of meat is stuffed into the sleeve and division points are incorporated along the length of the sleeve to divide the stuffed sleeve into the desired commercial size portions. The bag containing the meat product is then transported to a cooking or smoking facility and processed for market in the conventional manner. Bag formation and sealing are illustrated in the aforementioned U.S. Pat. No. 5,855,231. Of course because of the use of the casing of this invention with its superior properties, such stuffing, cooking, smoking and subsequent chilling and packaging can be performed much more efficiently and the resulting finished meat product has the optimum properties for market.

It will be evident that there are numerous embodiments of the present invention which are not expressly described above but which are clearly within the scope and spirit of the present invention. Therefore, the above description is intended to be exemplary only, and the actual scope of the invention is to be determined from the appended claims.

1. A casing for containment of a proteinaceous product which comprises a laminate comprising a first lamina which has sufficient strength to retain and shape said contained proteinaceous product and adhered thereto a second lamina of controlled porosity which is permeable to non-solids but impermeable to solids, such that said proteinaceous product may be removed from containment within said casing without delamination of said casing or deleterious effect on the surface of said proteinaceous product.

2. A casing as in claim 1 wherein said second lamina is permeable to both vapor and liquid.

3. A casing as in claim 1 wherein said second lamina is permeable to vapor but substantially impermeable to liquid.

4. A casing as in claim 1 wherein said first lamina comprises a knitted fabric.

5. A casing as in claim 4 wherein said knitted fabric has a coarse knit forming an open mesh.

6. A casing as in claim 5 wherein said knitted fabric comprises a high shrink yarn.

7. A casing as in claim 5 further comprising a finer knit fabric disposed within openings formed by said open mesh.

8. A casing as in claim 5 further comprising a strand which has reinforcement properties or high shrink properties or both disposed through said knitted fabric.

9. A casing as in claim 8 further wherein said knitted fabric comprises a high shrink yarn.

10. A casing as in claim 4 wherein said knitted fabric has a fine knit.

11. A casing as in claim 12 wherein said fine knit comprises a jersey, pique, rib or lacoste style.

12. A casing as in claim 13 wherein said fine knit comprises a jersey style.

13. A casing as in claim 4 further comprising a strand which has reinforcement properties or high shrink properties or both disposed through said knitted fabric.

14. A casing as in claim 4 wherein said knitted fabric comprises a tubular knitted fabric.

15. A casing as in claim 4 wherein said knitted fabric comprises fibers of nylon, cotton, rayon, acrylic, polyolefin, covered rubber or polyester.

16. A casing as in claim 1 wherein said second lamina comprises a porous sheeting material of nonwoven filter media, high wet strength paper or polymeric film.

17. A casing as in claim 16 wherein said second lamina comprises nonwoven filter media, said nonwoven filter media comprising at least one of polyolefin, polyester, nylon, microglass or polymeric fibers and in which fibers are spun bonded, melt blown, wet laid or dry laid to form said lamina.

18. A casing as in claim 16 wherein said high wet strength paper comprises a filter paper or membrane paper.

19. A casing as in claim 16 wherein said high wet strength paper comprises abaca pulp, wood fibers, glass fibers or cotton fibers.

20. A casing as in claim 19 wherein said high wet strength paper comprises abaca pulp.

21. A casing as in claim 16 wherein said second lamina comprises polymeric film, said polymeric film comprising a microporous film made of polyolefin, nylon or polyester.

22. A casing as in claim 1 wherein said first lamina and said second lamina are adhered by adhesive means.

23. A casing as in claim 22 wherein said adhesive means comprises radiation, chemical, thermal, pressure or solvent bonding of said laminae or mechanical interconnection between said laminae.

24. A casing as in claim 23 wherein said adhesive means comprises a thermally sensitive adhesive which is activated by application of heat.

25. A casing as in claim 22 wherein said adhesive means comprises an adhesive which is disposed at or near the surface of at least one said lamina and which is activated thermally, by pressure, chemically, by solvent or by radiation, such that upon application of activation means to said lamina said adhesive is activated and comes into contact with an opposed surface of the other lamina and effects bonding therebetween.

26. A casing as in claim 25 wherein said adhesive comprises at least a portion of fibers comprising said lamina.

27. A casing as in claim 1 wherein said laminae comprise portions which impart a formed pattern to a surface of said proteinaceous product.

28. A casing as in claim 27 wherein said pattern provides a visual appearance of a plurality of three-dimensional polygonal figures on the surface of the proteinaceous product.

29. A casing as in claim 1 further comprising an accessory material contained on the surface of or within a lamina which is transmitted to said proteinaceous product while said proteinaceous product is contained within said casing and which imparts a desired property to said proteinaceous product.

30. A casing as in claim 29 wherein said accessory material comprises a flavorant or colorant which imparts a flavor or color respectively to said proteinaceous product

31. A casing as in claim 1 wherein said controlled porosity of second lamina prevents significant exudation of proteins or fats from said proteinaceous product.

32. A casing as in claim 1 formed as an elongated hollow tube wherein said second lamina is disposed inwardly within said tube to be in contact with the surface of a proteinaceous product contained in said casing and said first lamina is disposed outwardly of said second lamina.

33. A casing as in claim 32 wherein said second lamina is formed to a greater diameter than said first lamina whereby said first lamina supports said second lamina and prevents tearing of said second lamina when said proteinaceous product is placed into said casing.

34. A casing as in claim 1 formed as an elongated hollow tube wherein said first lamina is disposed inwardly within said tube to be in contact with the surface of a proteinaceous product contained in said casing and said second lamina is disposed outwardly of said first lamina.

35. A casing as in claim 1 for containment of said proteinaceous product wherein said proteinaceous product comprises meat, poultry, seafood, soya or cheese.

36. A casing as in claim 1 for containment of said proteinaceous product during processing of said product comprising cooking, smoking, chilling or packaging.

37. A casing for containment of a proteinaceous product which comprises a laminate comprising a first lamina which has sufficient strength to retain and shape said contained proteinaceous product and adhered thereto a second lamina of controlled porosity formed of a high wet strength paper which is permeable to non-solids but impermeable to solids, such that said proteinaceous product may be removed from containment within said casing without delamination of said casing or deleterious effect on the surface of said proteinaceous product.

38. A casing as in claim 37 wherein said high wet strength paper comprises a filter paper or membrane paper.

39. A casing as in claim 37 wherein said high wet strength paper comprises abaca pulp, wood fibers, glass fibers or cotton fibers.

40. A casing as in claim 39 wherein said high wet strength paper comprises abaca pulp.

41. A casing as in claim 37 wherein said first lamina comprises a knitted fabric.

42. A casing as in claim 41 wherein said knitted fabric has a coarse knit forming an open mesh.

43. A casing as in claim 42 wherein said knitted fabric comprises a high shrink yarn.

44. A casing as in claim 42 further comprising a strand which has reinforcement properties or high shrink properties or both disposed through said knitted fabric.

45. A casing as in claim 44 further wherein said knitted fabric comprises a high shrink yarn.

46. A casing as in claim 42 wherein said knitted fabric comprises a coarse knit forming an open mesh with a finer knit fabric disposed within openings formed by said open mesh.

47. A casing as in claim 41 wherein said knitted fabric has a fine knit.

48. A casing as in claim 47 wherein said fine knit comprises a jersey, pique, rib or lacoste style.

49. A casing as in claim 48 wherein said fine knit comprises a jersey style.

50. A casing as in claim 41 wherein said knitted fabric comprises a tubular knitted fabric.

51. A casing as in claim 41 wherein said knitted fabric comprises fibers of nylon, cotton, rayon, acrylic, polyolefin, covered rubber or polyester.

52. A casing as in claim 37 wherein said first lamina and said second lamina are adhered by adhesive means.

53. A casing as in claim 52 wherein said adhesive means comprises radiation, chemical, thermal, pressure or solvent bonding of said laminae or mechanical interconnection between said laminae.

54. A casing as in claim 53 wherein said adhesive means comprises a thermally sensitive adhesive material which is activated by application of heat.

55. A casing as in claim 52 wherein said adhesive means comprises an adhesive which is disposed at or near the surface of at least one said lamina and which is activated thermally, by pressure, chemically, by solvent or by radiation, such that upon application of activation means to said lamina said adhesive is activated and comes into contact with an opposed surface of the other lamina and effects bonding therebetween.

56. A casing as in claim 55 herein said adhesive comprises at least a portion of fibers comprising said lamina.

57. A casing as in claim 37 wherein said laminae comprise portions which impart a formed pattern to a surface of said proteinaceous product.

58. A casing as in claim 57 wherein said pattern provides a visual appearance of a plurality of three-dimensional polygonal figures on the surface of the proteinaceous product.

59. A casing as in claim 37 further comprising an accessory material contained on the surface of or within a lamina which is transmitted to said proteinaceous product while contained within said casing and which imparts a desired property to said proteinaceous product.

60. A casing as in claim 59 wherein said accessory material comprises a flavorant or colorant which imparts a flavor or color respectively to said proteinaceous product

61. A casing as in claim 37 wherein said controlled porosity of second lamina prevents significant exudation of proteins or fats from said proteinaceous product.

62. A casing as in claim 37 wherein said second lamina is disposed inwardly within said tube to be in contact with the surface of a proteinaceous product contained in said casing and said first lamina is disposed outwardly of said second lamina.

63. A casing as in claim 62 wherein said second lamina is formed to a greater diameter than said first lamina whereby said first lamina supports said second lamina and prevents tearing of said second lamina when said proteinaceous product is placed into said casing.

64. A casing as in claim 37 for containment of said proteinaceous product wherein said proteinaceous product comprises meat, poultry, seafood, soya or cheese.

65. A casing as in claim 37 for containment of said proteinaceous product during processing of said product comprising cooking, smoking, chilling or packaging.

66. A method for manufacture of a casing for containment of a proteinaceous product comprising forming a first lamina which has sufficient strength to retain and shape said contained proteinaceous product;
forming a second lamina of controlled porosity which is permeable to non-solids but impermeable to solids; and
adhering said first lamina and said second lamina together to form said casing, said adhesion being such that said proteinaceous product may be removed from containment within said casing without delamination of said casing or deleterious effect on the surface of said proteinaceous product.

67. A method as in claim 66 wherein said forming of a first lamina comprises knitting of a fabric.

68. A method as in claim 67 comprising knitting said fabric with a coarse knit forming an open mesh.

69. A method as in claim 68 comprising knitting said fabric with a high shrink yarn.

70. A method as in claim 68 further comprising disposing a strand which has reinforcement properties or high shrink properties or both through said knitted fabric.

71. A method as in claim 70 further wherein said knitted fabric is knitted with a high shrink yarn.

72. A method as in claim 68 wherein said fabric is knitted with a coarse knit to form an open mesh having substantial openings therein and disposing a finer knit fabric within said openings.

73. A method as in claim 72 comprising knitting of said fabric with a fine knit.

74. A method as in claim 73 wherein said knitting comprises knitting of said fabric with a jersey, pique, rib or lacoste style.

75. A method as in claim 73 further comprising incorporating a strand which has reinforcement properties or high shrink properties or both disposed through said fabric.

76. A method as in claim 66 wherein said fabric is knitted from fibers of nylon, cotton, rayon, acrylic, polyolefin, covered rubber or polyester.

77. A method as in claim 66 wherein forming a second lamina comprises forming a porous sheeting material of nonwoven filter media, high wet strength paper or film from at least one of polyolefin, polyester, nylon, microglass or polymeric compositions.

78. A method as in claim 77 wherein said porous sheet material comprises a high wet strength paper.

79. A method as in claim 78 wherein said high wet strength paper comprises abaca pulp, wood fibers, glass fibers or cotton fibers.

80. A method as in claim 79 wherein said high wet strength paper comprises abaca pulp.

81. A method as in claim 66 wherein said adhering said first lamina and said second lamina together comprising adhesively bonding said laminae to form said casing.

82. A method as in claim 81 wherein adhesively bonding comprises applying an adhesive between and in contact with opposing surfaces of said laminae and activating said adhesive by thermal, chemical, solvent, radiation, or pressure means to effect an adhesive bond between said laminae to form said casing.

83. A method as in claim 81 wherein adhesively bonding comprises incorporating an adhesive into at least one said lamina, said adhesive being disposed at or near a surface of said lamina, bringing said surface of said lamina into contact with an opposing surface of the other lamina, and activating said adhesive by thermal, chemical, solvent, radiation, or pressure means to effect an adhesive bond between said laminae to form said casing.

84. A method as in claim 83 wherein said adhesive comprises at least a portion of the material from which said lamina has been formed.

85. A method as in claim 66 further comprising configuring said first lamina and said second lamina into an elongated tubular structure comprising said casing.

86. A method as in claim 85 further comprising disposing said second lamina inwardly of said casing to be in contact with the surface of a proteinaceous product contained in said casing and disposing said first lamina outwardly of said second lamina.

87. A method as in claim 66 said proteinaceous product to be contained within said casing comprises meat, poultry, seafood, soya or cheese.
